(19) United States
(12) Patent Application Publication
(10) Pub. No.: US 2009/0195157 A1
(43) Pub. Date: Aug. 6, 2009

(54) Plasma display device

(75) Inventor: Shinji Komaba, Fujisawa (JP)

Correspondence Address: STAAS & HALSEY LLP, SUITE 700, 1201 NEW YORK AVENUE, N.W., WASHINGTON, DC, 20005, US

(73) Assignee: HITACHI, LTD., Tokyo (JP)

(21) Appl. No.: 12/292,276

(22) Filed: Nov. 14, 2008

(30) Foreign Application Priority Data
Feb. 5, 2008 (JP) JP2008-024650

(51) Int. Cl. H01J 17/49

(52) U.S. Cl. 313/582

(57) ABSTRACT

A plasma display panel and a base chassis differ in thermal expansion coefficient due to the difference of their materials. Similarly, a circuit substrate and the base chassis differ in the thermal expansion coefficient. Since an ADM has a connection terminal portion fixed to the circuit substrate and a radiator plate fixed to the base chassis, the displacement occurs at the high temperature, and an electrode contact failure at the ADM connection terminal portion occurs. Accordingly, in the present invention, the radiator plate of the ADM is flexibly fixed to the base chassis by an elastic double-faced tape having sufficient flexibility, thereby reducing the displacement of the circuit substrate and the ADM due to the thermal expansion and preventing the displacement at the ADM connection terminal portion. Further, the ADM and the base chassis are electrically connected by a soft gasket, thereby preventing the noise generation on the ADM.

### CROSS-REFERENCE TO RELATED APPLICATION

The present application claims priority from Japanese Patent Application No. JP 2008-024650 filed on Feb. 5, 2008, the content of which is hereby incorporated by reference into this application.

### TECHNICAL FIELD OF THE INVENTION

The present invention relates to a plasma display device. Since the plasma display device can relatively easily achieve a high-speed response, a wide-viewing angle and a large size as compared with a liquid crystal display and is of a self-luminous type, the plasma display device is one of the flat panel display devices characterized by the high-quality image display.

### BACKGROUND OF THE INVENTION

In general, the plasma display device includes a plasma display panel, a base chassis disposed on the rear side of the plasma display panel, a circuit substrate disposed on the rear side of the base chassis, and an address driver module (hereinafter, referred to as ADM) that connects the circuit substrate and the plasma display panel and transmits the voltage from the circuit substrate to the plasma display panel. Here, the ADM includes, for example, an IC chip which is the address driver and a tape-shaped wiring member for mounting this IC chip. Further, the ADM includes a radiator plate which radiates heat from the IC chip of the ADM.

One end of the ADM is bonded by thermal compression to an end portion of the plasma display panel, and the other end thereof is connected to the connector of the circuit substrate. Further, the radiator plate of the ADM is completely fixed to the member attached to the base chassis by a screw and the like so as to sandwich the IC chip of the ADM.

Since problems such as distortion and displacement at the time of high temperature occur in this structure due to the difference in thermal expansion coefficient between the base chassis and the plasma display panel, a buffer plate having a movable mechanism and an adhesive agent having flexibility are provided between the base chassis and the ADM in some examples (International Publication No.07/007398).

### SUMMARY OF THE INVENTION

For the purpose of enhancing image quality of the plasma display device, introduction of a full high-definition (HD) has been in progress. In the conventional Full HD panel, a dual scan in which the ADM is disposed on both upper and lower sides of the panel has been the mainstream, but in order to reduce the circuit elements to achieve the cost reduction, a single scan in which the ADM is disposed on a single side has been adopted. When the driving is performed by the single scan, unlike the case of the dual scan, it is necessary to dispose the ADMs so as to be concentrated around one side of the plasma display panel. By the concentrated disposition of the ADMs, the local heat generation of the member has increased. Furthermore, due to the increase in size of the plasma display device, the influence due to the thermal expansion has become more significant. Therefore, it has been necessary to consider the influence on each member of the plasma display device due to the thermal expansion.

As described above, the plasma display panel and the base chassis are different in the thermal expansion coefficient due to the difference of their materials. Since one end of the ADM is connected to the plasma display panel and the portion having the radiator plate of the ADM is completely fixed to the member attached to the base chassis by the screw and the like, distortion occurs in the tape-shaped ADM at the time of high temperature.

Similarly, there is a difference in the thermal expansion coefficient between the circuit substrate and the base chassis. Therefore, in the connection terminal portion that connects the ADM to the circuit substrate, a contact failure of the electrodes may occur due to displacements of the circuit substrate and the ADM.

Therefore, a technique capable of preventing the distortion of the ADM even at the high temperature and the displacement of the circuit substrate and the ADM at the connection terminal portion that connects the ADM and the circuit substrate is necessary.

In consideration of the above described problems, the buffer plate having a movable mechanism has been provided between the base chassis and the ADM in the conventional technique. However, when the buffer plate having the movable mechanism is provided, since it is not sufficiently fixed, the ADM vibrates at the time of transportation, so that a force is applied to a connector that connects the ADM and the substrate, which sometimes leads to the occurrence of a contact failure of the electrodes.

Accordingly, we have conducted intensive study and development with respect to using a member such as an adhesive agent having flexibility between the base chassis and the ADM so that the base chassis and the ADM are sufficiently fixed and the vibration at the time of transportation does not cause problems, and we have revealed that there arises a new problem not found before such as the occurrence of noise in the image signal. This is considered to be due to that an unnecessary induced potential of the IC chip cannot be allowed to escape to the ground since the IC chip inside the ADM and the base chassis are electrically insulated when a member such as the adhesive agent having flexibility and the like is used.

Thus, the present invention provides a technique for suppressing the vibration at the time of panel transportation and the noise of the image signal, while preventing the distortion of the ADM due to the difference in the thermal expansion coefficient.

For the solution of the problems mentioned above, in the configuration of the present invention, an elastic adhesive member is used between the base chassis and the ADM, and the base chassis and the IC chip inside the ADM are electrically connected.

Specifically, the plasma display device of the present invention is configured to include, for example, a plasma display panel, a base chassis for supporting the plasma display panel, a driver circuit substrate having a driver circuit for driving the plasma display panel, an address driver module connected to the plasma display panel and the driver circuit substrate and performing the transmission of the image signal, a radiator plate for performing the heat radiation of the address driver module, an elastic adhesive member located between the address driver module and the base chassis, and a conductor for electrically connecting the radiator plate and the base chassis.

Further, the plasma display device according to another embodiment of the present invention is configured to include, for example, a conductive adhesive tape instead of providing the elastic adhesive member between the address driver module and the base chassis and the conductor electrically connecting the radiator plate and the base chassis.

By electrically connecting the base chassis and the IC chip inside the ADM as described above, it is possible to suppress the distortion of the image signal due to the occurrence of noise by the induced potential to the ADM caused by the insulation between the ADM and the chassis. Further, by fixing the basis chassis and the ADM with the elastic adhesive member, the distortion of the ADM due to the thermal expansion and the displacement of the connection terminal portion of the circuit substrate can be suppressed. Furthermore, an impact applied to the connector that connects the ADM and the substrate by the vibration at the time of transportation can be suppressed.

From the above, it is possible to suppress the impact applied to the conector at the time of transportation of the panel and the noise of the image signal, while preventing the distortion of the ADM due to the difference in thermal expansion coefficient.

### BRIEF DESCRIPTIONS OF THE DRAWINGS

FIG. 1 is a schematic side view of an ADM fixing method of a plasma display device according to a first embodiment;

FIG. 2 is a basic configuration diagram of the plasma display panel according the first embodiment;

FIG. 3 is an overall view of the plasma display device according to the first embodiment;

FIG. 4 is an overall view of the ADM according to the first embodiment;

FIG. 5A is a layout drawing of a soft gasket and a double-faced tape having sufficient flexibility;

FIG. 5B is a layout drawing of a conductive double-faced tape having flexibility;

FIG. 5C is a layout drawing of the soft gasket and the double-faced tape having sufficient flexibility;

FIG. 6 is a schematic side view of the vicinity of the IC chip according to the first embodiment;

FIG. 7A is a conceptual diagram of the displacement at the time of high temperature of the ADM of the plasma display device;

FIG. 7B is a diagram showing the regular position of the ADM of the plasma display device according to the first embodiment;

FIG. 7C is a diagram showing the deformation of the double-faced tape having sufficient flexibility of the plasma display device according to the first embodiment;

FIG. 8 is a schematic side view showing a fixing method of an address electrode driver circuit substrate of the plasma display device according to a second embodiment;

FIG. 9A is a conceptual diagram of the displacement at the time of high temperature of the TCP of the plasma display device;

FIG. 9B is a diagram showing the regular position of the TCP of the plasma display device according to the first embodiment;

FIG. 9C is a schematic diagram showing the deformation and the rotation of the double-faced tape having sufficient flexibility of the plasma display device according to the first embodiment; and

FIG. 10 is a schematic side view of the ADM fixing method of the plasma display device according to a third embodiment.

### DESCRIPTIONS OF THE PREFERRED EMBODIMENTS

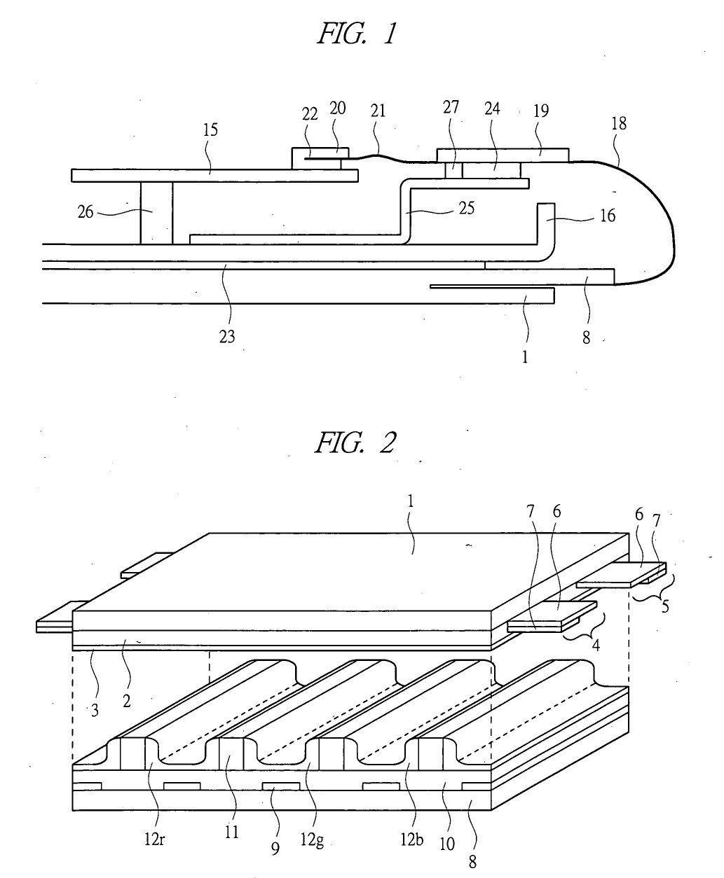

Embodiments of the present invention will be described below with reference to FIGS. 1 to 10.

FIG. 2 is an exploded perspective view showing the structure of a plasma display panel according to the present invention. As shown in the figure, the plasma display panel is configured by attaching together a front-glass substrate 1 and a rear-glass substrate 8 disposed oppositely and sealing discharge gas after evacuation. The rear-glass substrate 8 has a plurality of address electrodes 9 mutually in parallel, and these address electrodes 9 are covered with a dielectric layer 10. Barrier ribs 11 that form a discharge space are provided on the dielectric layer 10, and the lateral direction of the cell is partitioned by these barrier ribs 11. On the side surfaces of the barrier rib 11 and the dielectric layer 10, phosphors 12r, 12g, and 12b that emit visible lights of R, G, and B are applied. On the other hand, the front-glass substrate 1 is provided with pairs of scanning electrodes 5 and sustain discharge electrodes 4 composed of a plurality of display electrodes 6 and bus electrodes 7 mutually in parallel, which extend in the direction to intersect the address electrodes 9, and they are covered with a dielectric layer 2 and a protection film layer 3. As the discharge gas, at least one kind of rare gas such as neon, argon, krypton, and xenon or the mixture thereof is sealed in the discharge space partitioned by the barrier ribs.

By applying write-in pulse between the address electrode 9 and the scanning electrode 5 in such an electrode configuration, address discharge is performed between the address electrode 9 and the scanning electrode 5. After selecting the discharge cell by this address discharge, periodic pulse voltages inverted alternately are applied between the scanning electrode 5 and the sustain discharge electrode 4, whereby a sustain discharge is generated in the discharge space by an electric field generated between the surface of the protection film 3 through the dielectric layer 2 on the scanning electrode 5 and the surface of the protection film layer 3 through the dielectric layer 2 on the sustain discharge electrode 4, and a sustain discharge is performed between the scanning electrode 5 and the sustain discharge electrode 4. Ultraviolet rays generated by this sustain discharge excite the phosphors 12r, 12g, and 12b, and the visible lights from these phosphors 12r, 12g, and 12b are used for the display light emission.

FIG. 3 is a schematic diagram of the whole plasma display device shown in FIG. 2 seen from the circuit side placed on a base chassis 16 attached to the rear surface of the rear-glass substrate 8. First, as circuit substrates, a sustain electrode driver circuit substrate 13, a scanning electrode driver circuit substrate 14, and an address electrode driver circuit substrate 15 are mounted on the base chassis. Each driver circuit sends a drive waveform to each electrode. A flexible substrate 17a of the sustain electrode driver circuit substrate which is bonded by thermal compression to the front-glass substrate 1 and a flexible substrate 17b of the scanning electrode driver circuit substrate are connected to the sustain electrode driver circuit substrate 13 and the scanning electrode driver circuit substrate 14, respectively. The present invention is applied to the attachment of an ADM connected to a long side of the plasma display panel 8. The ADM (output side) 18 is bonded by thermal compression to the end portion of the rear-glass substrate 8, a radiator plate 19 is flexibly fixed to a reinforcement stay 25 completely fixed to the base chassis 16, and the input side 21 of the ADM is connected to a connector 20 of the address electrode driver circuit substrate 15. The ADM transmits the voltage supplied from the address electrode driver circuit substrate 15 to the plasma display panel 8.

FIG. 1 is a schematic diagram of the vicinity of the ADM 18 shown in FIG. 3 seen from the left side of FIG. 3. In this configuration, from the bottom of the figure, the front-glass substrate 1, the plasma display panel of the rear-glass substrate 8, and the double-faced tape 23 which adheres the plasma display panel 8 to the base chassis 16 are disposed below the base chassis 16. Further, the reinforcement stay 25 is fixed on the base chassis 16, and an elastic double-faced tape 24 having sufficient flexibility and a soft gasket 27 are mounted on the portion flexibly fixing the ADM radiator plate 19. By the adhesion of this double-faced tape 24, even when vibration is caused to the radiator plate 19 at the time of transportation and the like of the product, since the double-faced tape 24 having flexibility absorbs the impact, no contact failure occurs between the connector 20 and an ADM connection terminal portion 22. The soft gasket 27 is attached for the purpose of electrically connecting the ADM radiator plate 19 and the reinforcement stay 25 as well as the base chassis 16 and allowing the noise of the IC chip in the ADM to escape to the ground. Further, an address electrode driver circuit support member 26 for supporting the address electrode driver circuit substrate 15 is provided on the base chassis 16. Although the address electrode driver circuit support member 26 is fixed on the base chassis 16, since a screw hole portion of the electrode driver circuit substrate 15 has an allowance, even when the base chassis 16 is expanded by heat, the electrode driver circuit substrate 15 does not move in association with the base chassis 16. The connector 20 to which an ADM (input side) 21 is connected is provided on the address electrode driver circuit substrate 15. The surface of the reinforcement stay 25 to which the radiator plate 19 is fixed is configured to have the height matched with that of the place at which the connector 20 is positioned. Also, the ADM (output side) 18 is bonded by thermal compression to the rear-glass substrate 8.

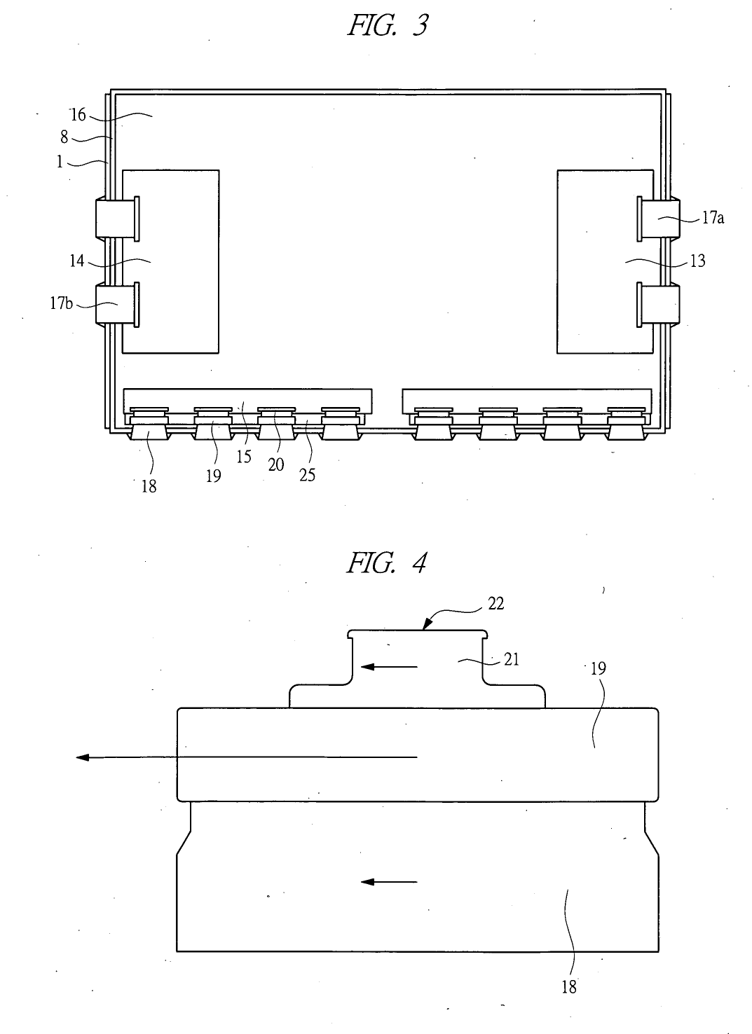

FIG. 4 is a view showing the details of the vicinity of the ADM of FIG. 3. Reference numeral 18 denotes the output side of the ADM, 21 denotes the input side of the ADM, and 19 denotes the radiator plate. Reference numeral 22 denotes the ADM connection terminal portion which is connected to the connector 20 of an address electrode driver circuit substrate 26. Further, although the ADM (output side) 18 and the ADM (input side) 21 are flexible in the direction vertical to the paper surface, they have no degree of freedom in the planar direction of the paper surface. When the double-faced tape is not used between the reinforcement stay 25 and the ADM, the ADM (input side) 21 moves in association with the thermal expansion of the address electrode driver circuit substrate 26. Further, the radiator plate 19 moves in association with the thermal expansion of the base chassis 16, and the ADM (output side) 18 moves in association with the thermal expansion of the plasma display panel 8. With respect to the plasma display panel 8 and the address electrode driver circuit substrate 26, the difference of the thermal expansion coefficient is not large. On the other hand, the base chassis is larger in thermal expansion coefficient than the plasma display panel 8 and the address electrode driver circuit substrate 26. Therefore, when the vicinity of the ADM becomes a high temperature, the radiator plate 19 moves in the direction of an arrow mark more largely than the ADM (input side) 21 and the ADM (output side) 18, respectively, and thus the distortion occurs in the ADM and displacement is caused between the ADM (input side) 21 and the ADM connection terminal portion.

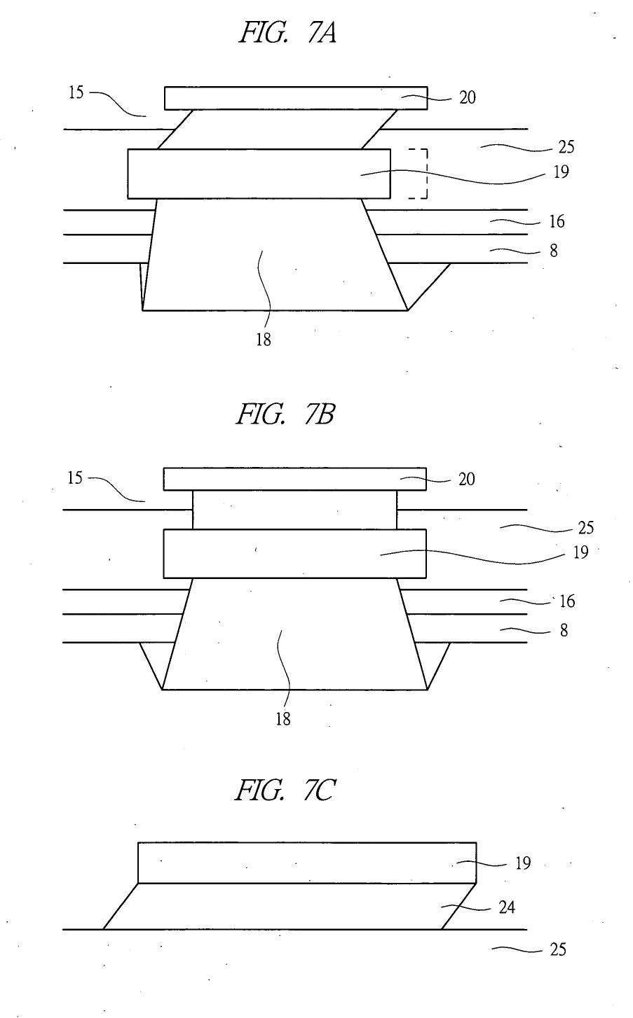

A principle to prevent the distortion and displacement described in FIG. 4 will be described with reference to FIGS. 7A, 7B, and 7C. FIGS. 7A and 7B respectively show a mounting state of the ADM in the case where the double-faced tape is not used between the reinforcement stay 25 and the ADM and in the case where it is used therebetween. The reinforcement stay 25 fixed on the base chassis 16 is provided, and the ADM radiator plate 19 is flexibly fixed on the reinforcement stay 25 by the double-faced tape. The ADM (output side) 18 is bonded by thermal compression to the rear-glass substrate 8. Reference numeral 1 denotes the front-glass substrate. The ADM (input side) is connected to the connector 20 on the address electrode driver circuit substrate 15.

At the time of high temperature, from the difference in the thermal expansion coefficients of the address electrode driver circuit substrate 15, the base chassis 16, and the plasma display panel 17, the base chassis 16 possibly moves in the planar direction as shown in FIG. 7A. At that time, the radiator plate 19 also moves in synchronization. FIG. 7A is a conceptual diagram thereof. When the present invention is applied, the radiator plate 19 is at a regular position as shown in FIG. 7B. FIG. 7C is a view of the radiator plate 19 of FIG. 7A seen from the side face. The mechanism that the radiator plate 19 comes to the regular position is the shear deformation of the double-faced tape 24 having sufficient flexibility as shown in FIG. 7C. With respect to the double-faced tape 24 having sufficient flexibility for the shear deformation, the double-faced tape 24 is required to have flexibility of such an extent that a shear retention force of the tape at that temperature is sufficiently smaller than a force by which the radiator plate 19 is pulled by the thermal expansion of the base chassis 16.

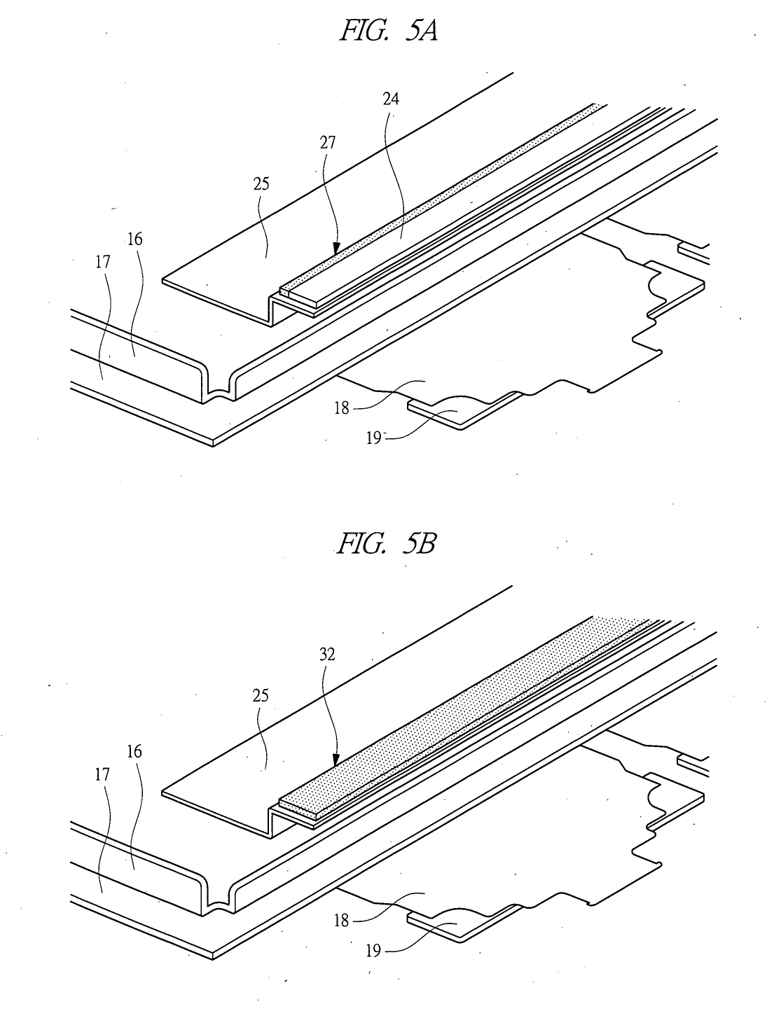

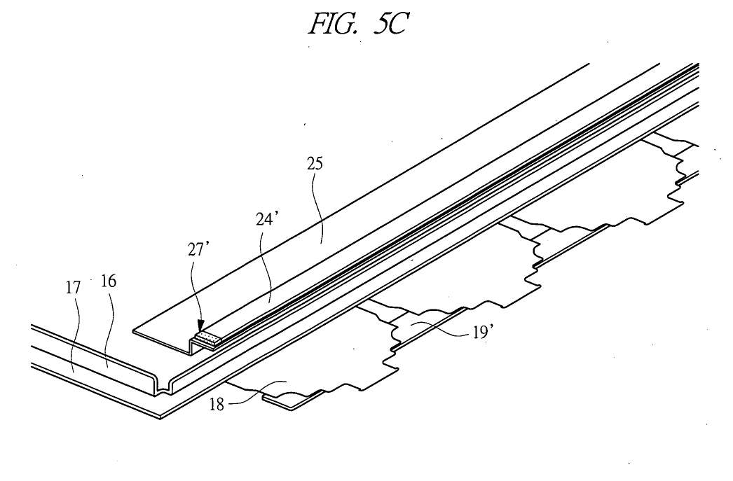

FIG. 5A is a perspective view showing the disposition of the double-faced tape 24 having sufficient flexibility and the soft gasket 27 attached to the reinforcement stay 25. The double-faced tape 24 having sufficient flexibility is adhered to the reinforcement stay 25 in advance in an elongated shape, and a plurality of ADMs are collectively fixed by one sheet of the double-faced tape 24 having sufficient flexibility. As shown in FIG. 3, since many ADMs are provided and are disposed in a row, the above described method is possible. Further, another reason why the double-faced tape 24 is formed to have an elongated shape and the ADMs are collectively fixed is that, if the ADMs are to be individually fixed, the number of the double-faced tapes and the number of man-hours for adhering the double-faced tapes are increased, and similarly, an operation of peeling off the release paper of the double-faced tape is probably required when fixing the ADMs and the number of man-hours for peeling off the release paper is also increased. The soft gasket 27 is disposed at a position in a direct contact with the radiator plate without interposing the ADM therebetween so as to electrically connect the radiator plate 19 and the base chassis 16.

FIG. 5B is a view showing the case where a conductive adhesive tape 32 is disposed for the reinforcement stay 25. Since the conductive double-faced tape is used, the cost is increased as compared with FIG. 5A. However, since a design can be done without using the soft gasket, the assembly becomes easy.

FIG. 5C shows an example in which one radiator plate 19 is used for a plurality of ADMs. For the plurality of ADMs, the induced potential of an IC chip 33 can be allowed to escape to the ground by electrically connecting the base chassis 16 to only one radiator plate 19. Therefore, a soft gasket 27′ may be disposed only at the position shown in FIG. 5C. As a result, the quantity of the soft gasket can be reduced and the cost reduction can be achieved in comparison with FIG. 5A.

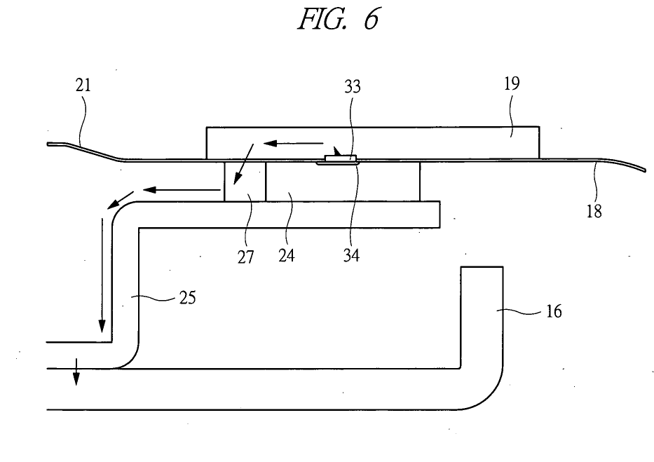

In FIG. 6, the functions of the soft gasket 27 and the conductive adhesive tape 32 of FIGS. 5A, 5B, and 5C will be described. The ADM incorporates the IC chip 33 and is fixed with silicon resin. The IC chip 33 is in contact with the radiator plate 19. The IC chip 33 has a function to determine to which cell of the plasma display panel 8 the current transmitted from the address electrode driver circuit substrate 26 is transmitted, but an induced potential could be generated when performing a specific display. When the induced potential is generated in the IC chip 33, a noise occurs in the image signal. Therefore, it is necessary that the IC chip 33 is electrically connected to the base chassis 8 serving as a ground so as to allow the induced potential of the IC chip 33 to escape to the ground. The induced potential generated in the IC chip 33 is allowed to escape to the reinforcement stay 25 and the base chassis 16 from the radiator plate 19 through the soft gasket 27 as shown by arrow marks of FIG. 6. In this manner, the IC chip 33 and the base chassis 16 are electrically connected. The soft gasket 27 is obtained by applying a film of a conductive material around the soft sponge of an elastic body, and is fixed to the radiator plate 19 side and the reinforcement stay 25 side by the conductive double-faced tape. Further, the shape of the soft gasket 27 is long and narrow as shown in FIG. 5, and it is positioned with a uniform height so as to contact the double-face tape 24. In the case of FIG. 5B, the radiator plate 19 and the reinforcement stay 25 are electrically connected by the conductive adhesive tape 32, and the conductive adhesive tape 32 functions as the soft gasket 27.

With respect to the thickness of the tape, it is assumed that a conceivable displacement of the connection terminal portion at the time when it is operated for a long period of time or when the high temperature load is applied thereto is 0.5 mm in the 50-inch plasma display device. Further, at this time, in the whole system in which the displacement occurs, a shear load of 40N is theoretically applied to the planar direction of the plasma display panel. The place at which the shear load of 40N is dispersed and applied includes the ADM input side 21, the connector portion 20, the fixed portion (double-faced tape 24) of the aluminum radiator plate 19, and the like, and it is assumed in this case that 10% of the shear load, that is, 4N is applied to the fixed portion (double-faced tape 24) of the aluminum radiator plate 19. Here, as one example of the double-faced tape 24, a relationship of the tape thickness, the shear load to be applied (shear retention force) and a shear deformation amount in the double-faced tape of a certain material is shown in Table 1. As shown in the column of 4N load in Table 1, if the tape thickness is 2 mm or more, the displacement of 0.5 mm of the connection terminal portion can be absorbed. It is preferable that the upper limit of the tape thickness is reduced as much as possible and is 1 cm or less when taking into consideration that the heat generated from the IC chip of the ADM is radiated to the base chassis 16. Also, Table 1 shows a test result at 75° C., but when taking into consideration of the heat generation of the ADM, there is a possibility that the actual double-faced tape partially reaches a temperature higher than 75° C. However, when the temperature of the double-faced tape becomes 75° C. or higher, the shear deformation amount of the double-faced tape becomes larger. In other words, the absorption of the displacement at the connection terminal portion becomes easy, and therefore, such a case is not considered this time, and discussion is made with the test result at 75° C.

TABLE 1

| | Thickness of Tape (mm) | | | |
|---|---|---|---|---|
| | 2.5 | 2 | 1.5 | 1 |
| 16N | 2.2 | 2 | 1.7 | 1.5 |
| Deformation Amount of Tape (mm) | | | | |
| 8N | 1.1 | 1 | 0.9 | 0.8 |
| Deformation Amount of Tape (mm) | | | | |
| 4N | 0.55 | 0.5 | 0.45 | 0.4 |
| Deformation Amount of Tape (mm) | | | | |

*16N, 8N, and 4N show the load applied to the radiator plate of the AMD in the shear direction. The deformation amount of the tape means a shear deformation amount of the double-faced tape that fixes the ADM radiator plate when applying the shear load.

In the present embodiment, even when thermal expansion occurs in each member due to the heat generation of the ADM, the displacement and the distortion of the ADM can be prevented by the double-faced tape 24, and since the soft gasket 27 and the conductive adhesive tape 32 are used, the induced potential generated in the IC chip 33 can be allowed to escape to the base chassis 16, and the generation of the noise of the image signal can be prevented.

As a second embodiment of the present invention, an example for the case where a compact tape carrier package (hereinafter, referred to as TCP) having no radiator plate unlike the conventional ADM is adapted and the displacement similarly occurs at the connector 20 on the address electrode driver circuit substrate 15 due to the thermal expansion of the base chassis 16 will be described.

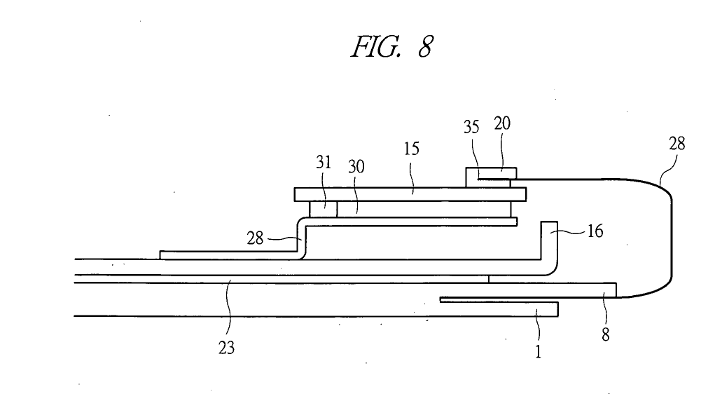

FIG. 8 is a schematic side view showing a flexible fixing method of the address electrode driver circuit substrate 15. Reference numeral 1 denotes the front-glass substrate and 8 denotes the rear-glass substrate, and similarly to the case of the ADM, the TCP 28 is bonded by thermal compression to the rear-glass substrate 8. Similarly, the plasma display panel is attached to the base chassis 16 by a double-faced tape 23. Reference numeral 29 denotes a reinforcement stay fixed to the base chassis 16, and it is different in shape from the reinforcement stay in the first embodiment and flexibly fixes the address electrode driver circuit substrate 15 with a double-faced tape 30 having sufficient flexibility and a soft gasket 31. Reference numeral 20 denotes the connector similarly to the first embodiment and the TCP 28 is connected thereto.

There is a possibility that the reinforcement stay 29 moves in the planar direction of the base chassis 16 together with the base chassis 16 due to the thermal expansion. At that time, the address electrode driver circuit substrate 15 synchronously moves in the planar direction of the base chassis 16, so that the displacement of a TCP connection terminal portion 35 at the connector portion 20 probably occurs. The mechanism for solving the displacement is the same as that of the first embodiment, in which the movement of the address electrode driver circuit substrate 15, that is, the displacement of the connection terminal portion at the connector portion 20 is prevented by the shear deformation of the double-faced tape 30 having sufficient flexibility and the soft gasket 31 in the direction of the thermal expansion of the base chassis 16. Further, the TCP 28 incorporates the IC chip 33. Also, different from the ADM of the first embodiment, the TCP is configured to have no radiator plate. In other words, since the TCP is not fixed to the radiator plate, the flexible region from the rear-glass substrate 8 to the connector portion 20 is long, and the degree of freedom is high. Therefore, the address electrode driver circuit substrate 15 fixed by the double-faced tape 30 having sufficient flexibility can prevent the displacement of the TCP connection terminal portion 35 at the connector portion 20 not only by the movement in the direction to the substrate surface but also by the rotation on the substrate surface.

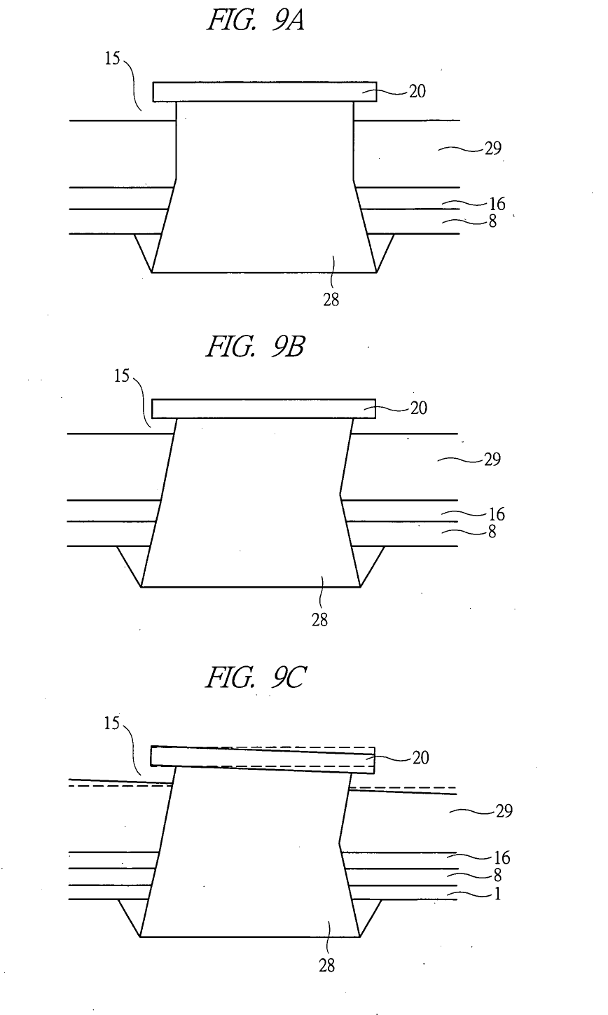

A principle to prevent the displacement at the connector 20 by the rotation of the address electrode driver circuit substrate 15 will be described with reference to FIGS. 9A, 9B, and 9C. FIG. 9A shows a mounted state of the ADM at the time of low temperature. FIG. 9B shows a mounted state of the ADM at the time of high temperature in the case where the double-faced tape is not used between the reinforcement stay 29 and the address electrode driver circuit substrate 15. At the time of low temperature, as shown in FIG. 9A, the connector 20 of the address electrode driver circuit substrate 15 moving in association with the radiator plate 16 is at the regular position. However, as shown in FIG. 9B, at the time of high temperature, the input side of the TCP 28 moves in association with the base chassis 16, the output side of the TCP 28 moves in association with the plasma display panel 8, and the displacement occurs between the TCP connection terminal and the connector 20. FIG. 9C shows a mounted state of the ADM at the time of high temperature in the case where the double-faced tape is used between the reinforcement stay 29 and the address electrode driver circuit substrate 15. When the double-faced tape is used between the reinforcement stay 29 and the TCP 28, the address electrode driver circuit substrate 15 rotates at the time of high temperature, so that the angle of the connector 20 changes as shown in FIG. 9C and the displacement of the TCP connection terminal portion 35 is prevented.

With respect to the tape thickness, since the TCP 28 has a high degree of freedom as described above, almost no force is applied to the connector 20. Therefore, in order to cause the movement in the direction to the address electrode driver circuit substrate described above and the rotation on the substrate surface thereof (FIG. 9C), the tape thickness is preferably large such as 3 to 4 mm as compared with the first embodiment.

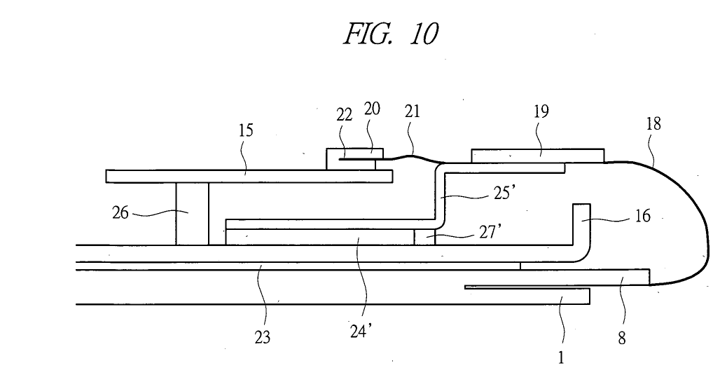

As a third embodiment of the present invention, an example in which a double-faced tape is used between the reinforcement stay 25 and the base chassis 16 will be described with reference to FIG. 10. FIG. 10 is a schematic diagram of the vicinity of an ADM in this embodiment seen from the side face of FIG. 3. In FIG. 10, different from FIG. 1, the double-faced tape 24′ and the soft gasket 27′ are used between the base chassis 16 and the reinforcement stay 25′.

Even in such a structure, as shown in FIG. 4, at the time of high temperature, the ADM (input side) 21 moves in association with the address electrode driver circuit substrate 26 and the ADM (output side) 18 moves in association with the plasma display panel, but the radiator plate 19 moves only at the same level as the ADM (input side) 21 and the ADM (output side) 18 because the double-faced tape 24′ below the reinforcement stay 25′ is deformed.

Accordingly, the displacement and the distortion of the ADM can be prevented. In this case, no double-faced tape may be used between the reinforcement stay 25′ and the radiator plate 19, and the reinforcement stay 25 and the radiator plate 19 can be fixed by screw. When the reinforcement stay 25 and the radiator plate 19 are fixed by screw, since the reinforcement stay 25 and the radiator plate 19 are electrically connected, if the reinforcement stay 25 using the double-faced tape 24′ and the base chassis 16 are electrically connected, the induced potential generated in the IC chip 33 can be allowed to escape to the base chassis 16. For this reason, the soft gasket 27′ is used between the reinforcement stay 25′ and the base chassis 16.

As described above, in this embodiment, there is no need to interpose the double-faced tape and the soft gasket between the reinforcement stay 25′ and the radiator plate 19. Therefore, this embodiment is effective when it is necessary to fix the reinforcement stay 25′ and the radiator plate 19 by screw.

What is claimed is:

1. A plasma display device, comprising:
a plasma display panel;
a base chassis for supporting the plasma display panel;
a driver circuit substrate having a driver circuit for driving the plasma display panel;
an address driver module connected to the plasma display panel and the driver circuit substrate and supplying voltage from the driver circuit of the driver circuit substrate to the plasma display panel;
a radiator plate for performing heat radiation of the address driver module;
an elastic adhesive member located between the address driver module and the base chassis; and
a conductor for electrically connecting the radiator plate and the base chassis.

2. A plasma display device, comprising:
a plasma display panel;
a base chassis for supporting the plasma display panel;
a driver circuit substrate having a driver circuit for driving the plasma display panel;
an address driver module connected to the plasma display panel and the driver circuit substrate and supplying voltage from the driver circuit of the driver circuit substrate to the plasma display panel;
a radiator plate for performing heat radiation of the address driver module; and
a conductive adhesive member located between the address driver module and the base chassis and electrically connecting the address driver module and the base chassis.

3. The plasma display device according to claim 1,
wherein the conductor is disposed between the address driver module and the base chassis and is a member obtained by covering an elastic body with a conductive adhesive member.

4. The plasma display device according to claim 1, further comprising:
a reinforcement stay between the radiator plate and the base chassis,
wherein the elastic adhesive member is located between the reinforcement stay and the address driver module.

5. The plasma display device according to claim 4, wherein the conductor or the conductive elastic adhesive member is in contact with the radiator plate and the reinforcement stay.

6. The plasma display device according to claim 1,
wherein the radiator plate is directly or indirectly connected to an IC chip of the address driver module.

7. The plasma display device according to claim 1,
wherein the elastic adhesive member is a double-faced tape with a thickness of 2 mm or more.

8. The plasma display device according to claim 1, further comprising:
a reinforcement stay between the radiator plate and the chassis,
wherein the elastic adhesive member is located between the base chassis and the reinforcement stay.

9. The plasma display device according to claim 8,
wherein the conductive member or the conductive elastic adhesive member is in contact with the reinforcement stay and the base chassis.

10. A plasma display device, comprising:
a plasma display panel;
a base chassis for supporting the plasma display panel;
a driver circuit substrate having a driver circuit for driving the plasma display panel;
an address driver module connected to the plasma display panel and the driver circuit substrate and supplying voltage from the driver circuit of the driver circuit substrate to the plasma display panel;
an elastic adhesive member located between the driver circuit substrate and the base chassis; and
a conductor electrically connecting the driver circuit substrate and the base chassis.

11. The plasma display device according to claim 10, further comprising:
a reinforcement stay between the driver circuit substrate and the chassis,
wherein the elastic adhesive member is located between the reinforcement stay and the driver circuit substrate.

12. A plasma display device, comprising:
a plasma display panel;
a base chassis for supporting the plasma display panel;
a driver circuit substrate having a driver circuit for driving the plasma display panel;
an address driver module connected to the plasma display panel and the driver circuit substrate and supplying voltage from the driver circuit of the driver circuit substrate to the plasma display panel;
a radiator plate for performing heat radiation of the address driver module;
an IC chip provided on the address driver module and converting a signal from the circuit substrate; and
an elastic adhesive member located between the address driver module and the base chassis,
wherein the IC chip and the base chassis are electrically connected.
